(19) United States
(12) Patent Application Publication
(10) Pub. No.: US 2026/0330069 A1
(43) Pub. Date: Oct. 22, 2026

(54) COMPUTING SYSTEM AND NON-TRANSITORY MACHINE-READABLE STORAGE MEDIUM FOR DATA MONITORING

(71) Applicant: Intel Corporation, Santa Clara, CA (US)

(72) Inventor: Robert L. VAUGHN, Portland, OR (US)

(21) Appl. No.: 19/281,813

(22) Filed: Jul. 28, 2025

(51) Int. Cl. G06F 21/71

(52) U.S. Cl. CPC G06F 21/71

(57) ABSTRACT

Provided is a non-transitory machine-readable medium storing machine-readable program. The program is, when executed by a secure processor in a computing system comprising a host processing unit running a host operating system, OS, configured to perform, without relying on the host OS, hardware-level monitoring on at least one device, and store information obtained based on the hardware-level monitoring.

### BACKGROUND

In some systems, root users have a plentiy of authorities. Even some advanced monitoring tools like auditd, Security-Enhanced Linux (SELinux), Extended Berkeley Packet Filter (eBPF), etc., are exposed to tampering by root or kernel-level attackers.

### BRIEF DESCRIPTION OF THE FIGURES

Some examples of apparatuses and/or methods will be described in the following by way of example only, and with reference to the accompanying figures, in which

FIG. 1 illustrates a block diagram of an example of computing system 100 for hardware-level data monitoring;

FIG. 2 illustrates a flow chart of an example of method 200 for hardware-level data monitoring;

FIG. 3 illustrates a flow chart of an example of method 300 for data transfer.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures identical or similar reference numerals refer to identical or similar elements and/or features, which may be identical or implemented in a modified form while providing the identical or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the identical combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the identical function. If a function is described below as implemented using multiple elements, further examples may implement the identical function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage medium accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the identical or different examples. Furthermore, the terms “comprising,” “including,” “having,” and the like, as used with respect to examples of the present disclosure, are synonymous.

FIG. 1 illustrates a block diagram of a computing system 100 of an example of the application.

In some examples, computing system 100 is a hardware-based architecture configured to implement hardware-based security monitoring, which may be referred to as Hardware-Enforced Privileged Security Monitor (HEPSM). The monitoring may address a growing need for trustworthy and tamper-resistant telemetry in environments where even the operating system (OS) or root-level access may be compromised. It may be configured to function or operate independently of traditional software stacks, offering continuous, hardware-enforced observability into system behavior such as file access, memory activity, and network communication. Unlike traditional security solutions that rely on software instrumentation, this system may employ a privileged, isolated hardware execution domain capable of monitoring all activities within the host system in real time.

Computing system 100 may comprise two main subsystems: a host domain/system 120 and a secure processing unit 140, where the secure processing unit140 may be referred to as Privileged Security Execution Engine (PSEE) 140. These two subsystems may be logically and/or physically separated, with secure processing unit 140 observing and verifying the behavior of the host domain through dedicated hardware interfaces and observational channels. This separation may enable independent auditing and monitoring of system behavior, even in the presence of malicious or compromised software in the host environment.

The host domain 120 may comprise the general-purpose computing resources of the system. It may include Host Processing Unit 122, Memory 124, I/O Bus 126 and Direct Memory Access (DMA) Controller 128. Host Processing Unit 122, such as a central processing unit (CPU), may be configured to run a host OS, such as Windows, MacOS or Android, and user-level applications. Memory 124 may be configured for program execution and/or data storage. I/O Bus 126 and DMA Controller 128 may be configured to perform communication and high-speed data transfer between peripherals and memory. All of these host-side components may operate without knowledge of or control over secure processing unit 140. System Bus Interface 129 links the host domain 120 to secure processing unit 140, enabling secure processing unit 140 to observe relevant data and control signals.

Secure processing unit 140 may operate or function as a hardware-isolated, tamper-resistant telemetry engine. As illustrated by FIG. 1, secure processing unit 140 may include secure processor 142, which may be referred to as Embedded Processor 142 in some examples. Secure processor 142 may be an ARM Cortex-M or Reduced Instruction Set Computer-Fifth Generation (RISC-V) core, which may execute a secure and immutable monitoring instruction set. This processor 142 may architecturally operate independently, triggering its own telemetry routines based on observed hardware events. Secure processing unit 140 may be coupled with a Logic-Logging, Crypto Engine, and Timing Logic 144, which collectively handle the secure generation, timestamping, and cryptographic sealing of telemetry data. These logs may be transmitted to external verifiers such as Trusted Execution Environments (TEEs), Hardware Security Modules (HSMs), or tamper-proof Write-Once Read-Many (WORM) media.

In some examples, secure processor 142 may exhibit a range of specialized characteristics that set it apart from general-purpose central processing unit, CPUs, or traditional security modules. For example, one of the roles of secure processor 142 is to execute a dedicated, immutable security monitoring instruction set, entirely independent of the host operating system (OS), hypervisor, or user-level software. This separation may be enforced both architecturally and physically, ensuring that the secure processor cannot be paused, reprogrammed, or observed by any software entity within the host domain, even those with root-level access.

Unlike enclaves such as Intel Software Guard Extensions (SGX), which depend on host OS coordination for input/output and operate within a constrained memory region, secure processor 142 may operate as a self-directed execution environment. It may initiate its own logic routines based on low-level hardware events, such as file I/O, memory access, or network activity, captured through direct hooks into system buses, CPU trace registers, and event triggers. These event sources are wired directly to secure processor 142, bypassing the need to trust any signals from the host OS. As a result, the processor may function as an always-on, tamper-resistant sentinel, capable of real-time system observation, anomaly detection, and telemetry collection—even in fully compromised environments.

In some examples, secure processor 142 may reside within the same silicon die or package as host processing unit 122, allowing tight integration with memory and I/O buses while remaining logically isolated. This configuration enables processor 142 to use techniques like DMA-based inspection to read host memory non-intrusively, ensuring the host cannot conceal or falsify data. Its execution path, which refers to sequence of operations, instructions, or code segments that a processor or system component follows while executing a particular task or program, may be enforced at the silicon level, meaning it is not subject to manipulation by the host processing unit's scheduler or interrupt model. This architectural enforcement may be used to establish a new layer of trust within the computing system, one that operates beneath the software stack and remains invisible to it.

Secure processor 142 may run its own lightweight operating system and/or trusted applications, such as telemetry collection agents, cryptographic modules, or secure log handlers. However, in some examples, secure processor 142 is configured not to depend on any host-reported data and/or to interact with host software through standard APIs. Such dependency might compromise its trust model. Instead, all monitored data, such as telemetry data, may be derived from direct hardware observations, making the processor suitable for applications that demand high-assurance monitoring.

In some examples, secure processing unit 140 may use a secure memory 146, which is inaccessible to host processing unit 122, to store sensitive monitoring data. Secure memory 146 may refer to one or more blocks of secure memory 146. In some examples, secure memory 146 may store telemetry buffers, cryptographic chains, and other security-critical metadata. A enabler of secure processing unit 140's functionality is Observational Channel 148, which may serve as a privileged path allowing secure processing unit 140 to monitor bus activity, DMA traffic, CPU trace signals, and other system events without relying on the host OS run by host processing unit 122. This channel allows secure processing unit 140 to passively observe low-level operations such as memory reads/writes, block-level storage access, system calls, and network traffic.

Secure Memory 146 in some examples may be isolated from the host system. Unlike some conventional system memory, secure memory 146 may be architecturally protected from any access by host processing unit 122, operating system, or hypervisor. This isolation may be enforced at the hardware level using techniques such as dedicated memory partitioning or fabric-level routing, effectively creating a protected enclave accessible only by the secure processing unit 140 and/or secure processor 142. Within this isolated domain, secure memory 146 may store data, such as telemetry buffers, cryptographic hash chains, and log entries, generated, obtained or monitored by secure processing unit 140. It may work in tandem with an integrated cryptographic engine, which may be implemented by secure processor 142, to seal and sign these logs, ensuring that any tampering, such as log modification, reordering, or rollback, is detectable through broken hash chains or signature mismatches. This tamper-evident capability may be needed for trustworthy auditing and forensic analysis, especially in environments where the host system may be compromised. Based on the features of the secure memory, it may be used to store security-critical data and intermediate cryptographic material in a space that remains immune to host-level threats.

In some examples, several hardware-level monitoring techniques may be applied in computing system 100. The techniques may include bus snooping, DMA-based memory inspection, CPU trace hook integration, and event-triggered telemetry logic. These techniques, separately or in combination, enable the secure processing unit 140 to detect file system activity, process execution, memory changes, and I/O patterns, such as those associated with writing to/var/log/audit/audit. log, without needing to trust the host OS's reporting. Furthermore, secure processing unit 140 can perform reverse block-to-file mapping by crawling filesystem metadata like inode tables storing metadata about files and directories, enabling it to correlate physical disk activity to specific files even when filenames are not directly visible.

In some examples, secure processing unit 140 may enhance system integrity through secure logging and offloading, where collected telemetry is cryptographically signed and protected before being exported. By leveraging its unique position within the system's hardware topology, secure processing unit 140 can detect and flag anomalies such as tampered audit logs, log rollbacks, and unexpected write patterns. Thus, it may redefine system trust by establishing a privileged execution and monitoring layer that is invisible, immutable, and independently verifiable.

In some examples, host processing unit 122 may include one or more (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute operations. In some examples, memory 124 may include a Random-Access Memory (RAM), a Dynamic Random-Access Memory (DRAM) and/or a Read-Only Memory (ROM), and secure memory 146 may include a Static Random-Access Memory (SRAM), embedded Magnetoresistive Random Access Memory (eMRAM), Resistive Random Access Memory (RRAM), and/or Flash. In some examples, the computing system may be a system board, an SoC, a device, a server or a network system including devices residing at different physical locations.

In general, Computing System 100 in some examples may enable a resilient and high-assurance telemetry framework, capable of continuous monitoring and post-compromise forensic validation. It provides a new trust foundation for secure systems, particularly in zero-trust environments or regulated computing contexts where reliable auditability and tamper resistance are paramount.

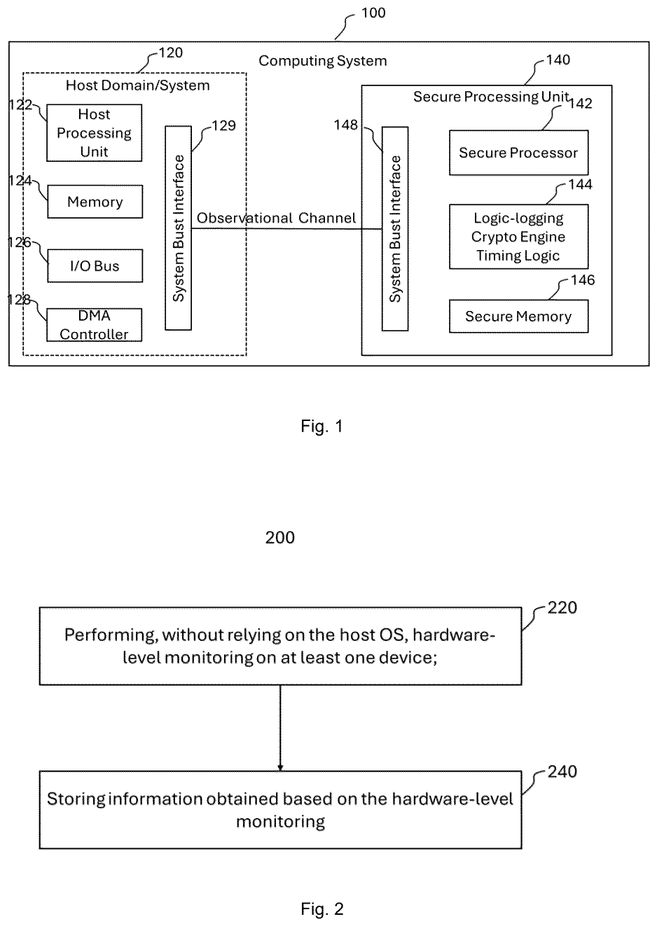

FIG. 2 illustrates a flow chart of method 200 for data monitoring of an example of the application.

In some examples, method 200 may be implemented by a computing system, such as computing system 100. In some particular examples, method 200 may be implemented by a secure processing unit, such as secure processing unit 140. In some more particular examples, method 200 may be implemented when a machine-readable program stored in a non-transitory machine-readable medium, such as secure memory 146, is executed by a secure processor, such as secure processor 142.

As illustrated by FIG. 2, method 200 may include performing, without relying on the host OS, hardware-level monitoring on at least one device at operation 220, and may further including storing information obtained based on the hardware-level monitoring at operation 240. Because host OS is not relied on for monitoring, tamper resistance, integrity, and trustworthiness of the data monitoring may be obtained even if the host OS is compromised.

In some examples, the host OS may be Windows by Microsoft, Android by Google or MacOS by Apple. In some examples, without relying on the host OS may refer to that some or all information or instruction associated with data monitoring sent by the host OS is not trusted and/or used for the data monitoring. The information obtained based on the hardware-level monitoring may refer to information monitored by the hardware-level monitoring and/or information generated based on the information monitored by the hardware-level monitoring.

In some examples, without relying on the host OS may alternatively or further refer to that the monitored data is isolated from the host OS. For example, the monitored data may be stored to a secure memory isolated from the host OS. As the hardware-level monitoring is not relied on the host OS, even if the host OS is compromised, the compromised host OS cannot threaten the correctness of the hardware-level monitoring by providing false information or instructions.

In some examples, the at least one device may refer to a component of a network device, or a personal computer, a server. For example, it may refer to a network interface card, a hard disk, a memory or a processing unit. In some other examples, the at least one device may refer to a device or a component attachable or connectable to host device, where the attachable or connectable device may refer to an external hard disk or a network storage device.

In some examples, techniques of hardware-level monitoring may comprise hardware bus snooping and tap points, CPU trace hooks and debug extension, integrated hardware event triggers, DMA-based memory inspection and/or secure logging and offloading. These techniques are used, independently or in combination, to perform the hardware-level monitoring.

In some examples, the monitoring may be on an operation to a block of a storage device of the at least one device. Upon this, the monitoring in method 200 may include determining a file that is fully or partially stored in the block based on a monitored identifier of the block and a correspondence between the identifier and the file. In such examples, the operation to the block of the storage device may include storing the file, fully or partially, to the block. The storage device may refer to a hard disk device, a Random Access Memory (RAM) or a Read Only Memory (ROM).

In some examples, method 200 may further include monitoring the identifier of the block based on at least one of a bus coupled with the storage device or hardware-level DMA monitoring. The bus and the DMA may be used to monitor the identifier of the block independently or in combination. The correspondence may be stored in a data structure of a file system storing metadata about files. Normally, the data structure of the file system, such as inode tables, directory entries, superblocks, or journal logs, is stored on the same physical storage device as the file system itself, such as a hard disk (HDD), solid-state drive (SSD), or NVMe drive. In some more specific examples, the identifier is a logical or physical address of the block. The metadata about the file may comprise at least one of a type of the file, a timestamp of the operation, a size of data processed by the operation, or a frequency of a plurality of operations sharing a type of the operation to the block.

In some examples, the at least one device may comprise the host processing unit, such as processing unit 122. Upon this, the information obtained based on the hardware-level monitoring may comprise information of at least one of a type of a system call, a process issued a system call, a memory region accessed by a system call, an execution flow of a program comprising a system call or a custom-defined behavior. In some examples, a system call may allow a program to request low-level functions that are restricted or privileged. The functions may include reading from or writing to files, allocating memory, creating or managing processes, accessing hardware devices, and/or networking operations.

In some more particular examples, the information obtained based on the hardware-level monitoring may be determined based on information obtained by the secure processing unit from the host processing unit via a hardware trace and debug mechanism. Some examples of the hardware trace and debug mechanism may include Processor Trace (PT) provided by Intel, Embeddedd Trace Macrocell (ETM) provided by ARM, Lastt Branch Record (LBR) provided by Intel, and custom microcode hooks or debug extensions.

In some more particular examples, the information obtained by the secure processing unit from the host processing unit may comprise at least one of occurrence of the system call, context switching indicating a transition between processes or threads on the host processing unit, or a memory region accessed by the system call.

In some examples, the at least one device comprises a network device, such as a network interface card. Upon this, the monitoring in method 200 may be performed on packets from and/or to the network device before the packets reach the host OS. In a more specific example, the information obtained based on the hardware-level monitoring may comprise at least one of information associated with traffic of the packets, or information associated with content inspection on the packets.

In some examples, the computing system may be an SoC, a personal computer, a network device, or a server. The host processing unit may be a CPU, and the security processing unit may be a secure engine comprising an embedded processor 142 and a secure memory 146.

A technical solution or system of some examples of the application may be referred to as Hardware-Enforced Privileged Security Monitor (HEPSM). It may solve a fundamental problem of trustworthy system monitoring in environments where even the root users or operating system kernels cannot be fully trusted.

In some systems, root access may grant unrestricted control, allowing attackers or insiders to disable telemetry tools, forge audit logs, or erase traces of malicious activity. Solutions or tools like auditd, SELinux, or kernel modules all operate within the same trust boundary as the Operating System (OS), making them vulnerable to compromise.

The technical solution presented in some examples, such as the HEPSM, may address this by operating at a privilege level below the OS. The privilege level may be enforced at the hardware level, where it remains inaccessible to any software running on the system. It may continuously observe system behavior, such as file access, process execution, memory activity, and network communication, directly via hardware interfaces, without relying on the operating system for event visibility. The continuous observation may gather accurate, tamper-evident data, such as telemetry, that can be cryptographically signed or sent to a secure enclave for further processing. Based on this, HEPSM may enable post-compromise forensics, regulatory compliance, and zero-trust enforcement, even in the presence of sophisticated threats with full root access. It may establish a new trust foundation, ensuring that system integrity and behavior can be independently verified, regardless of the state of the host OS.

In some examples, an engine for security protection is provided for the technical solution, where the engine may be referred to as Privileged Security Execution Engine (PSEE) or a different name. In some examples, the engine may refer to secure processing unit 140 exemplarily comprising secure processor 142 and secure memory 146. Some traditional security modules operate within OS kernels or rely on co-processors and passively receive commands. Unlike those modules, the engine in the examples may be a hardware-integrated execution environment that operates at a privilege level architecturally above the operating system, hypervisor, and any user-level code. It may execute a dedicated, immutable security monitoring instruction set that cannot be paused, modified, or overwritten by the host system even by users with root access or direct kernel privileges. It's immune to compromise even if the OS or hypervisor is fully controlled by an attacker. Unlike enclaves such as Intel SGX, which operate in isolated silos representing a closed self-contained system, and require OS coordination for inputs, this engine runs autonomously, initiating its own observations and logic based on hardware-level event triggers. Its execution path, a specific sequence of instructions or operations that the engine follows while performing its tasks, is enforced at the silicon level and is not visible or controllable from the host CPU scheduling model. The trust model of system security may be fundamentally changed by creating an execution layer that monitors other events or entities while remaining itself hidden from observation. It may enable high-assurance telemetry collection and tamper-resilient auditing even in fully compromised environments.

The engine, such as secure processing unit 140, may be implemented as a dedicated microcontroller or low-power core, such as a small ARM Cortex-M or RISC-V core, embedded into the same package or die as the main CPU. The engine may function similarly to Intel's Management Engine (ME) or Apple's Secure Enclave, but with a fundamentally different role. It not only responds to OS requests, but also actively observes and autonomously executes privileged monitoring tasks.

The engine, such as secure processing unit 140, may run its own OS and may be able to run some tools such as auditd to collect telemetry data from the host OS, including network Input/Output (I/O), file I/O and file access operations, such as read/write. If it is architected that the host OS runs an agent to collect the actual data and exposes it via an API to the engine, which may be referred to PSEE, the approach is flawed. It is because it would require the engine to trust the host OS.

The engine, such as secure processing unit 140, may employ one or more hardware-level techniques to collect data, such as telemetry data, independently of the host operating system's trustworthiness.

In some examples, the hardware-level techniques may include hardware bus snooping and tap points. In this example, the engine may be directly wired into relevant system buses or interfaces, such as the memory bus, Peripheral Component Interconnect Express (PCIe) Interfaces, and Serial Advanced Technology Attachment/Non-Volatile Memory Express (SATA/NVMe) interfaces. It may allow the engine to passively observe low-level operations such as block-level read and write activity at the storage controller, DMA-based transfers associated with network traffic at the network interface card (NIC), and memory-mapped I/O interactions. The read and write activity at the storage controller may occur as a result of file I/O operations initiated by software applications or the OS. The DMA-based transfer may refer to data movement operations that use DMA. This approach may mirror the functionality of logic analyzers and I/O Memory Management Units (IOMMUs). It is integrated into system silicon, such as CPU cores, memory controllers, security engines, and/or embedded processors, for real-time analysis. For instance, when a file is read from disk, the engine may directly observe the SATA/NVMe controller transmitting the read request to memory via DMA, bypassing the need to rely on the OS for this information. In some examples, the system silicon may refer to main integrated circuit (IC) or set of chips that form the core hardware platform of a computing system. It may include an SoC in embedded or mobile devices, a CPU die, chipset, or custom silicon in servers, PCs, or accelerators, and co-integrated hardware blocks that are part of the system's primary semiconductor package.

In some examples, the hardware-level techniques may include CPU trace hooks and debug extension. According to this technique, the engine may monitor process-level context switching, system calls, and memory access patterns by tapping into CPU trace and debug mechanisms, such as Intel's Processor Trace (PT) and ARM's Embedded Trace Macrocell (ETM), through their associated control registers. For even finer-grained control, custom microcode hooks can be implemented to emit specific signals that the engine is designed to interpret. In other words, the engine may use custom microcode hooks to monitor operations. CPU trace hooks and debug extension and related mechanisms may allow the engine to infer system calls like read, write, open, and exec, and track the originating process without any reliance on the host OS reporting this activity.

In some examples, the hardware-level techniques may utilize integrated hardware event triggers. In some specific hardware-level events, such as file system access, system calls, or the arrival and transmission of packets at the network interface card, can be configured to trigger alerts to the engine without reliance on the host OS. These triggers are distinct from OS interrupts, operating instead as low-level hardware signals exclusively accessible to the engine. This mechanism is conceptually similar to performance counters or System Management Mode (SMM) triggers, but instead of notifying the Basic Input/Output System (BIOS) or operating system, it routes events directly to a dedicated hardware engine for processing.

In some examples, the hardware-level techniques may include DMA-based memory inspection. According to this inspection, the engine may be granted privileged, read-only DMA to the host system's Random Access Memory (RAM). It enables the engine to inspect critical data structures, such as process tables, in-memory file buffers, and system call arguments and results, without relying on the cooperation of the host CPU or OS. The isolation from host CPU or OS may ensure that the monitored system cannot conceal or falsify the data being inspected.

In some examples, the hardware-level techniques may include secure logging and offloading, which is for improving the integrity and verifiability of the collected data. The data, such as telemetry data, gathered by the engine may be cryptographically signed and sealed within the secure environment of the engine itself to achieve secured data. Then, the secured data may be transmitted to a Trusted Execution Environment (TEE) or a Hardware Security Module (HSM), offloaded to write-once read-many (WORM) media for tamper-proof storage, or hashed and sent to remote auditors for independent verification. TEE or HSM may achieve that the data is handled or analyzed in a trustworthy space, preserving integrity by avoiding exposure to untrusted software. Offloading the data to WORM media may achieve that the data cannot be silently modified later, boosting verifiability for regulators or investigators.

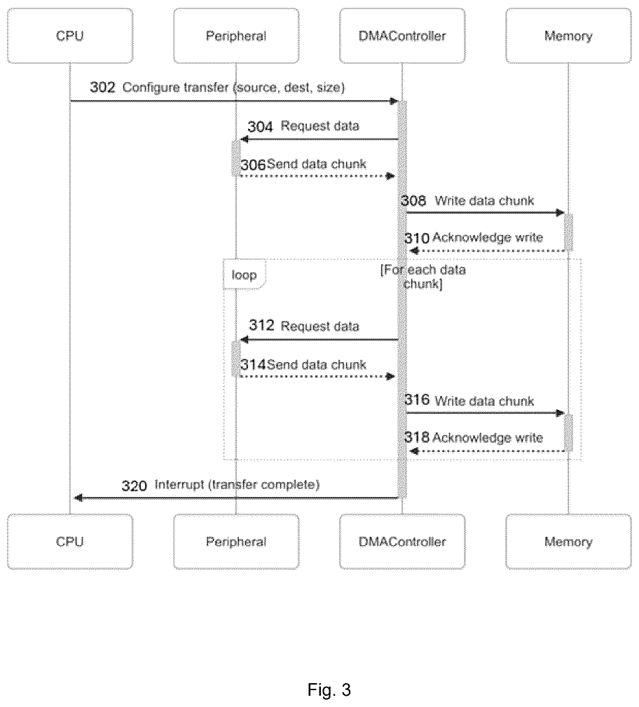

FIG. 3 illustrates a flow chart of DMA-based interaction between hardware components of an example of the application.

At operation 302, CPU, such as host CPU 122, configures DMA Controller, such as DMA Controller 128, with parameters of requested data. The parameters may include a source address of the data, a destination address of the data and/or the size of the data.

At operation 304, DMA Controller requests a data chunk based on at least one of the parameters. For example, DMA Controller may request Peripheral to provide the data by providing the source address and size of the data chunk to the Peripheral. Peripheral may refer to a peripheral device, such as a network interface card or a storage controller.

At operation 306, DMA Controller may send the requested data chunk to DMA Controller.

At operation 308, DMA Controller may write the requested data chunk to Memory, such as Memory 124.

At operation 310, Memory may acknowledge the write of the data chunk after the write is finished.

At operation 312, after the data chunk is written to Memory, DMA Controller may start a new process of writing a new data chunk. Thus, DMA Controller may send a new request for a new data chunk to Peripheral. The following operations 314 to 318 are similar to operations 306 to 310, implementing the write of the new data chunk to Memory.

At operation 320, when all data chunks requested by CPU is written to Memory, DMA Controller may send an interruptive message to CPU, indicating the completion of the data transfer.

The engine may be configured to observe the above exact low-level flows illustrated in FIG. 3. The observation may comprise DMA activity between the peripheral and memory, timing and sequence of memory writes, and/or host CPU's configuration of the DMA controller. Since the OS is not involved in each individual chunk transfer, it may not even be aware of all the activity. The observation may be independent of OS APIs or kernel hooks. By contrast, secure processing unit, such as PSEE, may monitor this exchange passively in real time, thereby ensuring comprehensive, tamper-resistant telemetry.

In some examples, when an auditd daemon on Linux may record audit events in the file located at/var/log/audit/audit. log, a secure engine, such as the secure processing unit 140, may observe writes or reads to from those file blocks. It is because some examples of the application have potential for separate trust zones. In existing and traditional systems, everything runs within the same trust domain governed by the host OS and thus no part of the system can be reliably trusted if the OS is compromised. In some examples of the application, a separate trust zone is created in hardware, and it can observe, validate, and/or store data, such as telemetry data, independently. Even if the host OS is malicious, the secure engine, such as secure processing unit 140, may make reliable and tamper-resistant observations and logs.

The engine's ability to monitor a audit. log file without OS intervention may rely on observing the underlying block-level operations, where the underlying block-level operations may refer to read and write commands that access data in fixed-size blocks, such as 512 bytes or 4 KB, on a storage device such as an HDD, SSD, or NVMe drive. The/var/log/audit/audit. log file, which resides within a file system such as ext4, is subject to translation by the kernel whenever auditd writes to it. These write operations manifest as changes to the file system's metadata and as actual block-level I/O operations directed to the physical disk, e.g., /dev/sda or /dev/nvme0n1. These I/O commands may be issued to the disk controller through interfaces such as DMA, PCIe, SATA, or NVMe. The engine's monitoring occurs at the level of the I/O bus or DMA traffic, completely bypassing the file system call abstraction.

Some advantages may be achieved by the engine based on the memory or I/O bus, either through physical connections via fabric routing or virtual integration within the SoC. From this position, the engine may observe several crucial details: the specific blocks being written, the precise timestamps of the I/O operations, the size and frequency of the write activity, and potentially even the contents of the data buffers, depending on the access method employed such as snooping memory before a DMA flush.

While the engine does not inherently “see” the filename /var/log/audit/audit.log, it may identify the physical or logical blocks being accessed. Through pre-analysis or by crawling the file system tables using its privileged DMA access, it may correlate these accessed blocks with known file locations.

In some examples, the engine may perform file-level mapping. By utilizing its read-only DMA capabilities, the engine may scan the file system's metadata structures, such as inode tables and journal logs. This allows the engine to perform reverse mapping from physical blocks to their corresponding filenames, enabling it to determine, for example, that “Block 0x3E7 is part of /var/log/audit/audit.log.” This process operates independently of the host OS, relying instead on the engine's knowledge of standard file system layouts, such as the documented structures of ext4.

The low-level monitoring capability described in some examples may enable the engine to effectively detect tampering attempts. If a root-level attacker tries to alter or delete audit logs, or modify past entries, the engine may observe unusual activity. This may include detecting unexpected read-modify-write cycles, identifying block overwrite patterns that deviate from the expected append-only behavior of a log file, and recognizing file system journal replay or rollback attempts. Furthermore, the engine may compare the observed log activity against cryptographic hash chains securely sealed within its own protected memory. By comparing the observed log activity against cryptographic hash chains securely sealed within its own protected memory, the engine may verify the integrity of the audit trail and detect signs of tampering. Any mismatch between the live log behavior and the expected hash values may indicate unauthorized modifications, such as altered or deleted entries, log rollback, or reordering.

Because of the ability to detect and log every read and write operation to the physical blocks corresponding to the audit. log file, the engine may operate entirely outside the control and visibility of the host OS. While the engine does not inherently understand filenames, it can correlate disk blocks to specific files by crawling file system metadata without relying on the integrity of the OS.

Some further examples of the application are provided as follows.

An example (e.g. example 1) relates to a computing system, comprising a host processing unit, configured to run a host operating system, OS. It further comprises a secure processing unit, configured to perform, without relying on the host OS, hardware-level monitoring on at least one device, and store information obtained based on the hardware-level monitoring.

An example (e.g., example 2) relates to a previously described example (e.g., example 1) or to any of the examples described herein, wherein upon that the monitoring is on an operation to a block of a storage device of the at least one device, the secure processing unit is configured to determine a file that is fully or partially stored in the block based on a monitored identifier of the block and a correspondence between the identifier and the file.

An example (e.g., example 3) relates to a previously described example (e.g., example 2) or to any of the examples described herein, wherein the secure processing unit is configured to monitor the identifier based on at least one of a bus coupled with the storage device or hardware-level Direct Memory Access, DMA, monitoring.

An example (e.g., example 4) relates to a previously described example (e.g., example 2 or 3) or to any of the examples described herein, wherein the correspondence is stored in a data structure of a file system storing metadata about files.

An example (e.g., example 5) relates to a previously described example (e.g., any one of examples 2 to 4) or to any of the examples described herein, wherein the identifier is a logical address of the block.

An example (e.g., example 6) relates to a previously described example (e.g., example 4 or 5) or to any of the examples described herein, wherein the metadata about the file comprise at least one of a type of the file, a timestamp of the operation, a size of data processed by the operation, or a frequency of a plurality of operations sharing a type of the operation to the block.

An example (e.g., example 7) relates to a previously described example (e.g., any one examples 1 to 6) or to any of the examples described herein, wherein upon that the at least one device comprises the host processing unit, the information obtained based on he hardware-level monitoring comprise information of at least one of a type of a system call, a process issued a system call, a memory region accessed by a system call, an execution flow of a program comprising a system call or a custom-defined behavior.

An example (e.g., example 8) relates to a previously described example (e.g., example 7) or to any of the examples described herein, wherein the information obtained based on the hardware-level monitoring is determined based on information obtained by the secure processing unit from the host processing unit via a hardware trace and debug mechanism.

An example (e.g., example 9) relates to a previously described example (e.g., example 8) or to any of the examples described herein, wherein the information obtained by the secure processing unit from the host processing unit comprises at least one of occurrence of the system call, context switching indicating a transition between processes or threads on the host processing unit, or a memory region accessed by the system call.

An example (e.g., example 10) relates to a previously described example (e.g., any one of examples 1 to 9) or to any of the examples described herein, wherein upon that the at least one device comprises a network device, the secure processing unit is configured to perform the monitoring on packets from and/or to the network device before the packets reach the host OS.

An example (e.g., example 11) relates to a previously described example (e.g., example 10) or to any of the examples described herein, wherein the information obtained based on the hardware-level monitoring comprises at least one of information associated with traffic of the packets, or information associated with content inspection on the packets.

An example (e.g., example 12) relates to a previously described example (e.g., any one of examples 1 to 11) or to any of the examples described herein, wherein the computing system is a System-on-a-Chip, SoC, a personal computer or a server, wherein the host processing unit is a Central Processing Unit, CPU, and wherein the security processing unit is a secure engine comprising an embedded processor and a secure memory.

An example (e.g., example 13) relates to a previously described example (e.g., any one of examples 1 to 12) or to any of the examples described herein, wherein the secure processing unit is further configured to cryptographically sign the information obtained based on the monitoring; and send the signed information to an entity for security-related analysis.

An example (e.g., example 14) relates to a previously described example (e.g., any one of examples 1 to 13) or to any of the examples described herein, wherein the host processing unit and the secure processing unit are on one same diet, or on different diets.

An example (e.g. example 15) relates to a non-transitory machine-readable medium storing machine-readable program, wherein the program is, when executed by a secure processor in a computing system comprising a host processing unit running a host operating system, OS, configured to perform, without relying on the host OS, hardware-level monitoring on at least one device, and store information obtained based on the hardware-level monitoring.

An example (e.g., example 16) relates to a previously described example (e.g., example 15) or to any of the examples described herein, wherein upon that the monitoring is on an operation to a block of a storage device of the at least one device, the program, when executed, is configured to determine a file that is fully or partially stored in the block based on a monitored identifier of the block and a correspondence between the identifier and the file.

An example (e.g., example 17) relates to a previously described example (e.g., example 16) or to any of the examples described herein, wherein the program, when executed, is configured to monitor the identifier based on at least one of a bus coupled with the storage device or hardware-level Direct Memory Access, DMA, monitoring.

An example (e.g., example 18) relates to a previously described example (e.g., example 16 or 17) or to any of the examples described herein, wherein the correspondence is stored in a data structure of a file system storing metadata about files.

An example (e.g., example 19) relates to a previously described example (e.g., any one of examples 16 to 18) or to any of the examples described herein, wherein the identifier is a logical address of the block.

An example (e.g., example 20) relates to a previously described example (e.g., example 18 or 19) or to any of the examples described herein, wherein the metadata about the file comprise at least one of a type of the file, a timestamp of the operation, a size of data processed by the operation, or a frequency of a plurality of operations sharing a type of the operation to the block.

An example (e.g., example 21) relates to a previously described example (e.g., any one of examples 15 to 20) or to any of the examples described herein, wherein upon that the at least one device comprises the host processing unit, the information obtained based on the hardware-level monitoring comprises information of at least one of a type of a system call, a process issued a system call, a memory region accessed by a system call, an execution flow of a program comprising a system call or a custom-defined behavior.

An example (e.g., example 22) relates to a previously described example (e.g., example 21) or to any of the examples described herein, wherein the information obtained based on the hardware-level monitoring is determined based on information obtained from the host processing unit via a hardware trace and debug mechanism.

An example (e.g., example 23) relates to a previously described example (e.g., example 22) or to any of the examples described herein, wherein the information obtained from host processing unit comprises at least one of occurrence of the system call, context switching indicating a transition between processes or threads on the host processing unit, or a memory region accessed by the system call.

An example (e.g., example 24) relates to a previously described example (e.g., any one of examples 15 to 23) or to any of the examples described herein, wherein upon that the at least one device comprises a network device, the program is configured to perform the monitoring on packets from and/or to the network device before the packets reach the host OS.

An example (e.g., example 25) relates to a previously described example (e.g., example 24) or to any of the examples described herein, wherein the information obtained based on the hardware-level monitoring comprises at least one of information associated with traffic of the packets, or information associated with content inspection on the packets.

An example (e.g., example 26) relates to a previously described example (e.g., any one of examples 15 to 25) or to any of the examples described herein, wherein the secure processor is independent from an operation system run on a Central Processing Unit, CPU.

An example (e.g., example 27) relates to a previously described example (e.g., any one of examples 15 to 26) or to any of the examples described herein, wherein the program, when executed, is configured to cryptographically sign the information obtained based on the monitoring and send the signed information to an entity for security-related analysis.

An example (e.g. example 28) relates to a method for data monitoring, the method comprising: performing, without relying on a host OS, hardware-level monitoring on at least one device, and storing information obtained based on the hardware-level monitoring, wherein the method is performed by a secure processing unit included a computing system, and wherein the computing system includes a host processing unit running the host OS.

An example (e.g., example 29) relates to a previously described example (e.g., example 28) or to any of the examples described herein, wherein upon that the monitoring is on an operation to a block of a storage device of the at least one device, the secure processing unit is configured to determine a file that is fully or partially stored in the block based on a monitored identifier of the block and a correspondence between the identifier and the file.

An example (e.g., example 30) relates to a previously described example (e.g., example 29) or to any of the examples described herein, wherein the secure processing unit is configured to monitor the identifier based on at least one of a bus coupled with the storage device or hardware-level Direct Memory Access, DMA, monitoring.

An example (e.g., example 31) relates to a previously described example (e.g., example 29 or 30) or to any of the examples described herein, wherein the correspondence is stored in a data structure of a file system storing metadata about files.

An example (e.g., example 32) relates to a previously described example (e.g., any one of examples 29 and 31) or to any of the examples described herein, wherein the identifier is a logical address of the block.

An example (e.g., example 33) relates to a previously described example (e.g., example 31 or 32) or to any of the examples described herein, wherein the metadata about the file comprise at least one of a type of the file, a timestamp of the operation, a size of data processed by the operation, or a frequency of a plurality of operations sharing a type of the operation to the block.

An example (e.g., example 34) relates to a previously described example (e.g., any one examples 28 to 33) or to any of the examples described herein, wherein upon that the at least one device comprises the host processing unit, the information obtained based on the hardware-level monitoring comprise information of at least one of a type of a system call, a process issued a system call, a memory region accessed by a system call, an execution flow of a program comprising a system call or a custom-defined behavior.

An example (e.g., example 35) relates to a previously described example (e.g., example 34) or to any of the examples described herein, wherein the information obtained based on the hardware-level monitoring is determined based on information obtained by the secure processing unit from the host processing unit via a hardware trace and debug mechanism.

An example (e.g., example 36) relates to a previously described example (e.g., example 35) or to any of the examples described herein, wherein the information obtained by the secure processing unit from the host processing unit comprises at least one of occurrence of the system call, context switching indicating a transition between processes or threads on the host processing unit, or a memory region accessed by the system call.

An example (e.g., example 37) relates to a previously described example (e.g., any one of examples 28 to 36) or to any of the examples described herein, wherein upon that the at least one device comprises a network device, the secure processing unit is configured to perform the monitoring on packets from and/or to the network device before the packets reach the host OS.

An example (e.g., example 38) relates to a previously described example (e.g., example 37) or to any of the examples described herein, wherein the information obtained based on the hardware-level monitoring comprises at least one of information associated with traffic of the packets, or information associated with content inspection on the packets.

An example (e.g., example 40) relates to a previously described example (e.g., any one of examples 28 to 39) or to any of the examples described herein, wherein the computing system is a System-on-a-Chip, SoC, a personal computer or a server, wherein the host processing unit is a Central Processing Unit, CPU, and wherein the security processing unit is a secure engine comprising an embedded processor and a secure memory.

An example (e.g., example 41) relates to a previously described example (e.g., any one of examples 28 to 40) or to any of the examples described herein, wherein the secure processing unit is further configured to cryptographically sign the information obtained based on the monitoring; and send the signed information to an entity for security-related analysis.

An example (e.g., example 42) relates to a previously described example (e.g., any one of examples 28 to 41) or to any of the examples described herein, wherein the host processing unit and the secure processing unit are on one same diet, or on different diets.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor-or computer-readable and encode and/or contain machine-executable, processor-executable or computer-executable programs and instructions.

Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or SoCs systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps,-functions,-processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A computing system, comprising:
a host processing unit, configured to run a host operating system, OS; and
a secure processing unit, configured to
perform, without relying on the host OS, hardware-level monitoring on at least one device, and
store information obtained based on the hardware-level monitoring.

2. The computing system of claim 1, wherein upon that the monitoring is on an operation to a block of a storage device of the at least one device, the secure processing unit is configured to determine a file that is fully or partially stored in the block based on a monitored identifier of the block and a correspondence between the identifier and the file.

3. The computing system of claim 2, wherein the secure processing unit is configured to monitor the identifier based on at least one of a bus coupled with the storage device or hardware-level Direct Memory Access, DMA, monitoring.

4. The computing system of claim 2, wherein the correspondence is stored in a data structure of a file system storing metadata about files.

5. The computing system of claim 2, wherein the identifier is a logical address of the block.

6. The computing system of claim 4, wherein the metadata about the file comprises at least one of a type of the file, a timestamp of the operation, a size of data processed by the operation, or a frequency of a plurality of operations sharing a type of the operation to the block.

7. The computing system of claim 1, wherein upon that the at least one device comprises the host processing unit, the information obtained based on the hardware-level monitoring comprise information of at least one of a type of a system call, a process issued a system call, a memory region accessed by a system call, an execution flow of a program comprising a system call or a custom-defined behavior.

8. The computing system of claim 7, wherein the information obtained based on the hardware-level monitoring is determined based on information obtained by the secure processing unit from the host processing unit via a hardware trace and debug mechanism.

9. The computing system of claim 8, wherein the information obtained by the secure processing unit from the host processing unit comprises at least one of occurrence of the system call, context switching indicating a transition between processes or threads on the host processing unit, or a memory region accessed by the system call.

10. The computing system of claim 1, wherein upon that the at least one device comprises a network device, the secure processing unit is configured to perform the monitoring on packets from and/or to the network device before the packets reach the host OS.

11. The computing system of claim 10, wherein the information obtained based on the hardware-level monitoring comprises at least one of information associated with traffic of the packets, or information associated with content inspection on the packets.

12. The computing system of claim 1, wherein the computing system is a System-on-a-Chip, SoC, a personal computer or a server, wherein the host processing unit is a Central Processing Unit, CPU, and wherein the security processing unit is a secure engine comprising an embedded processor and a secure memory.

13. The computing system of claim 1, wherein the secure processing unit is further configured to:
cryptographically sign the information obtained based on the monitoring; and
send the signed information to an entity for security-related analysis.

14. The computing system of claim 1, wherein the host processing unit and the secure processing unit are on one same diet, or on different diets.

15. A non-transitory machine-readable medium storing machine-readable program, wherein the program is, when executed by a secure processor in a computing system comprising a host processing unit running a host operating system, OS, configured to:
perform, without relying on the host OS, hardware-level monitoring on at least one device, and
store information obtained based on the hardware-level monitoring.

16. The medium of claim 15, wherein upon that the monitoring is on an operation to a block of a storage device of the at least one device, the program, when executed, is configured to determine a file that is fully or partially stored in the block based on a monitored identifier of the block and a correspondence between the identifier and the file.

17. The medium of claim 16, wherein the program, when executed, is configured to monitor the identifier based on at least one of a bus coupled with the storage device or hardware-level Direct Memory Access, DMA, monitoring.

18. The medium of claim 16, wherein the correspondence is stored in a data structure of a file system storing metadata about files.

19. The medium of claim 15, wherein upon that the at least one device comprises the host processing unit, the information obtained based on the hardware-level monitoring comprises information of at least one of a type of a system call, a process issued a system call, a memory region accessed by a system call, an execution flow of a program comprising a system call or a custom-defined behavior.

20. The medium of claim 15, wherein upon that the at least one device comprises a network device, the program is configured to perform the monitoring on packets from and/or to the network device before the packets reach the host OS.
